(19) United States
(12) Patent Application Publication
(10) Pub. No.: US 2003/0075060 A1
(43) Pub. Date: Apr. 24, 2003

(54) Arrangement for adjusting the interval between the rotational axes of cylinders

(76) Inventor: Stephan Rolf Plewa, Schloss Holte-Stukenbrock (DE)

Correspondence Address: Douglas R Hanscom, Jones Tullar & Cooper, Eads Station, PO Box 2266, Arlington, VA, 22202, US

(21) Appl. No.: 10/257,984

(22) PCT Filed: Feb. 5, 2001
(86) PCT No.: PCT/DE01/00436

(51) Int. Cl. B41F 13/28

(52) U.S. Cl. 101/216; 101/247; 101/218

(57) ABSTRACT

The invention relates to an arrangement for adjusting the interval (E) between rotational axes (11,08) from a print-on position to a print-off position. A printing gap can be regulated separately and in a differentiated manner using cylinder liners (09,12), as a result of the effective direction of the eccentricity of the cylinder liner extending approximately parallel to a connecting line between rotational axes of two adjacent cylinders.

The invention relates to an arrangement in accordance with the preamble of claim 1 or 2 for setting the spacing between the axes of rotation of cylinders.

Printing units are known from DE 42 11 379 A1, whose ink application rollers are each seated on both sides in two adjustable eccentric bushes.

EP 0 591 792 A1 discloses a rubber blanket cylinder of a printing press whose journal is seated in a first eccentric bush for putting it into or out of the printing position, and in a second bush for setting the paper thickness.

The object of the invention is based on creating an arrangement for the selective setting of the spacing between two cylinders of a printing press.

In accordance with the invention, the object is attained by means of the characteristics of claim 1 or 2.

The advantages which can be achieved by means of the invention lie in particular in that by means of a shaft journal seating in accordance with the invention it is possible on the one hand to move a cylinder, for example a rubber blanket cylinder, away from one or two adjoining cylinders of a printing unit. On the other hand, a separate differentiated setting of a print gap toward an adjoining cylinder can be performed by simple technical means without changing the print gap toward a second adjoining cylinder.

An exemplary embodiment of the invention is represented in the drawings and will be described in greater detail in what follows.

Shown are in:

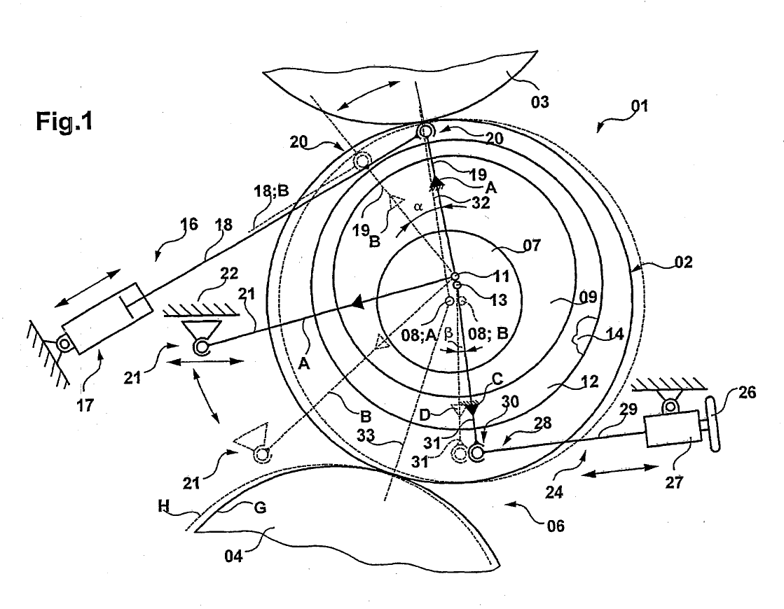

FIG. 1, a lateral view by means of a schematic printing position of a cylinder of an arrangement for placing a cylinder into a print-on and print-off position,

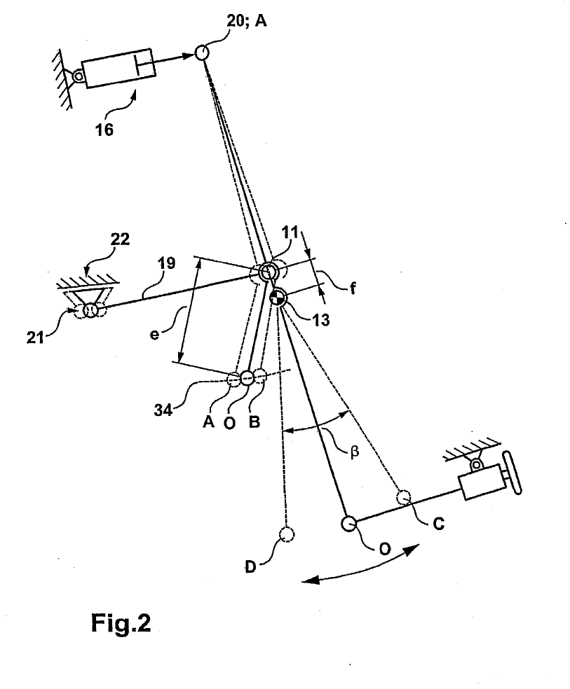

FIG. 2, an enlarged representation of the journal areas of a cylinder in FIG. 1 with a paper thickness setting device.

A transfer cylinder 01, for example a rubber blanket cylinder 01 of a printing unit of a rotary printing press, is represented in the lateral view in FIG. 1, whose periphery 02 rests against the periphery of a forme cylinder 03. The rubber blanket cylinder ol can be placed against a counter-pressure cylinder 04, for example a second rubber blanket cylinder 04, and is represented in this position by solid lines. A print gap 06 for the passage, i.e. for printing a paper web, not represented, is formed between the two cylinders 01, 04.

A cylinder journal 07, for example a shaft journal of the rubber blanket cylinder 01, which has a cylinder axis or axis of rotation 08, is seated in a first eccentric cylinder bush 09 having a cylinder axis or axis of rotation 11. It is now possible to obtain an eccentricity e of, for example 12 mm, between both axes of rotation 08, 11.

The first eccentric cylinder bush 09 is rotatably seated in a second eccentric cylinder bush 12, which has an axis of rotation 13. The second cylinder bush 12 is seated so it can be twisted in a bore 14 of a lateral frame of the printing press, not represented. By means of this second eccentric cylinder bush 12 it is possible to obtain an eccentricity f of 3 mm, for example, between the axis of rotation 11 of the first cylinder bush 09 and the axis of rotation 13 of the second cylinder bush 12. It is possible to arrange rolling bearings, not represented, in particular needle bearings or cylinder roller bearings, between each of the cylinder journal 07, first cylinder bush 09, second cylinder bush 12, as well as the bore 14. Any other type of rolling bearing or sliding bearing is also conceivable.

The ratio of the eccentricities e/f lies in the range of 2 to 6, preferably 3 to 5, in particular 3.5 to 4.5.

The first cylinder bush 09 can be pivoted, for example by means of a linear drive mechanism 16, over a setting angle α of 20 to 30°, for example 25°, out of a print-on position A into a print-off position B (shown by dashed lines in FIG. 1). In this case the linear drive mechanism 16 can consist of a work cylinder 17, for example a double-action compressed air cylinder, pivotably seated in a lateral frame, the free end 18 of whose piston rod is connected via a joint 20 with a bracket 19 fastened to the side of the first eccentric cylinder bush 09. A second bracket 21, whose free end is used as a support, is arranged at approximately 90 degrees in respect to the bracket 19 on the side of the cylinder bush 09. In the print-on position A, this support works together with a stop 22 fixed on the lateral frame. In this case the stop 22 can be embodied as a sliding bearing 22, for example.

The second cylinder bush 12 can be pivoted, for example by means of a linear drive mechanism 24, over a setting angle β of approximately two to five degrees, for example three degrees, out of a wide setting C of the printing gap 06 into a narrow setting D of the printing gap 06.

The linear drive mechanism 24 can for example consist of a. threaded spindle drive, or worm drive 27, hinged on the lateral frame and operable by means of a hand wheel 26. A free end 28 of the threaded spindle 29, or worm drive 27, is connected via a joint 30 to a bracket 31, which is fastened on the side of the second eccentric cylinder bush 12.

The arrangement operates as follows: the rubber blanket cylinder 01 can be brought from the print-on position A into the print-off position B by actuating the working cylinder 17, and therefore twisting the first eccentric cylinder bush 09 (FIG. 1). In the process, the present printing gap 06 between the rubber blanket cylinders 01, 04 is increased to a print-off position, and simultaneously the printing gap 06 between the rubber blanket cylinder 01 and the forme cylinder 03 is increased to a print-off position.

The rubber blanket, or counter-pressure cylinder 04 can also be displaced from a print-on position G into a print-off position H by means of eccentric bushes, not represented.

Because of the activation of the linear drive 24 for displacing the second eccentric cylinder bush 12, it is possible in the print-on position A of the rubber blanket cylinder 01 to achieve a change of the width of the printing gap 06, for example from −50 μm to +100 μm from the set zero position. This takes place between the narrow setting D and the wide setting C of the printing gap 06 (FIG. 2), for example between ±50 μm.

The effective direction of the eccentricity f of the second cylinder bush 12 extends approximately parallel with an imagined connecting line 32 between the axis of rotation 08 of the rubber blanket cylinder ol and an axis of rotation, not represented, of the adjoining forme cylinder 03.

The axes of rotation 08 of the cylinders 01, 04 are connected by the imagined connecting line 33.

If, because of a reduced paper thickness, the printing gap 06 between the cylinders 01, 04 existing in the print-on position A is to be changed from a normal position O, for example for a weight of 80 g/m², to a narrow setting D, the linear drive 24 is moved to the left (FIG. 2).

If a wide setting C of the printing gap 06 is to be achieved, the linear drive 24 is moved from the normal position O in the opposite direction.

In the course of the displacement of the eccentric second cylinder bush 12 over its axis of rotation 13 by means of the linear drive 24, the first eccentric cylinder bush 09, as well as the support 21 are displaced on the sliding bearing 22. The axis of rotation 11 of the first cylinder bush 09 changes its position O-C, or O-D parallel with a setting curve 34 of the paper thickness described by the axis of rotation 08 of the rubber blanket cylinder 01 when the paper thickness changes.

Each point on the setting curve 34 has approximately the same distance to the axis of rotation of the forme cylinder 03 and therefore does not change this distance, i.e. the periphery 02 of the rubber blanket cylinder ol remains in the vicinity of the periphery of the forme cylinder 03.

Approximately parallel is to be understood to be an opening angle between two straight lines of ±10°, in particular ±5°.

### LIST OF REFERENCE SYMBOLS

01 Transfer cylinder, rubber blanket cylinder

02 Periphery (01)

03 Forme cylinder

04 Counter-pressure cylinder, rubber blanket cylinder

05 -

06 Printing gap (01, 04)

07 Cylinder journal (01)

08 Axis of rotation (01, 07)

09 Cylinder bush, first (01)

10 -

11 Axis of rotation (09)

12 Cylinder bush, second (01)

13 Axis of rotation (12)

14 Bore (12)

15 -

16 Linear drive

17 Working cylinder (16)

18 End piston rod (17)

19 Bracket (09)

20 Joint (19, 18)

21 Support, bracket

22 Stop, sliding bearing

23 -

24 Linear drive

25 -

26 Hand wheel (27)

27 Worm drive

28 End (29)

29 Threaded spindle (27)

30 Joint (31, 12)

31 Bracket (12)

32 Connecting line (01, 03)

33 Connecting line (04, 01)

34 Setting curve of the paper thickness

A Print-on position (01)

B Print-off position (01)

C Wide setting (06)

D Narrow setting (06)

G Print-on position (04)

H Print-off position (04)

O Normal position (06)

e Eccentricity (09)

f Eccentricity (12)

α Setting angle (A, B)

β Setting angle (C, D)

1. An arrangement for setting a distance (e) between axes of rotation (11, 08) in a rotary printing press by means of a first cylinder bush (09) for the eccentric (e) seating of a cylinder journal (07) for a print-on, or print-off position (A, B) of a rubber blanket cylinder (01) against a counter-pressure cylinder (04), as well as a second eccentric (f) cylinder bush (12) for setting a variable printing gap (06) between the rubber blanket cylinder (01) and the counter-pressure cylinder (04), characterized in that a ratio (e/f) of the eccentricity (e) of the first cylinder bush (09) to the eccentricity of the second cylinder bush (12) is less than 6 greater than 2, i.e. 2<e/f<6.

2. An arrangement for setting a distance (e) between axes of rotation (11, 08) in a rotary printing press by means of a first cylinder bush (09) for the eccentric (e) seating of a cylinder journal (07) for a print-on, or print-off position (A, B) of a rubber blanket cylinder (01) against a counter-pressure cylinder (04), as well as a second eccentric (f) cylinder bush (12) for setting a variable printing gap (06) between the rubber blanket cylinder (01) and the counter-pressure cylinder (04), characterized in that in the print-on position (A) of the rubber blanket cylinder (01) a support (21) fastened on the first cylinder bush (01) is in an operative connection with a sliding bearing (22) fixed on a lateral frame, that an effective area of the sliding bearing (22) is arranged approximately parallel with a connecting straight line of the end points of the setting curve (34) of the axis of rotation (08) of the rubber blanket cylinder (01).

3. The arrangement in accordance with claim 1 or 2, characterized in that the counter-pressure cylinder (04) is embodied as a rubber blanket cylinder (04).

4. The arrangement in accordance with claim 1 or 2, characterized in that a connecting straight line (11) of the first cylinder bush (09) and an axis of rotation (13) of the second cylinder bush (12) extend parallel in respect to the connecting lines (32) between the axis of rotation (08) of the rubber blanket cylinder (01) and the axis of rotation of an adjacent forme cylinder (03).
